(19) United States
(12) Patent Application Publication
(10) Pub. No.: US 2011/0115790 A1
(43) Pub. Date: May 19, 2011

(54) APPARATUS AND METHOD FOR CONVERTING 2D IMAGE SIGNALS INTO 3D IMAGE SIGNALS

(75) Inventors: Ji Sang Yoo, Seoul (KR); Yun Ki Baek, Gyeonggi-do (KR); Se Hwan Park, Seoul (KR); Jung Hwan Yun, Seoul (KR); Yong Hyub Oh, Seoul (KR); Jong Dae Kim, Seoul (KR); Sung Moon Chun, Gyeonggi-do (KR); Tae Sup Jung, Seoul (KR)

(73) Assignees: ENHANCED CHIP TECHNOLOGY INC, Seoul (KR); KWANGWOON UNIVERSITY INDUSTRY-ACADEMIC COLLABORATION FOUNDATION, Seoul (KR)

(21) Appl. No.: 13/054,431

(22) PCT Filed: Aug. 26, 2008
(86) PCT No.: PCT/KR2008/004990

§ 371 Date: Jan. 14, 2011

(51) Int. Cl. G06T 15/00

(52) U.S. Cl. 345/419

(57) ABSTRACT

The present inventive concept can be used in a wide range of applications, including: mobile devices, such as mobile phones; an image processing apparatus or processor and computer programs, including a member for converting 2D image signals into 3D image signals or using an algorism for converting 2D image signals into 3D image signals.

### TECHNICAL FIELD

The present inventive concept relates to an apparatus for converting image signals, and more particularly, to an apparatus and method for converting 2D image signals into 3D image signals.

### BACKGROUND ART

Recently, as three dimensional (3D) stereoscopic images draw more attentions, various stereoscopic image acquisition apparatuses and displaying apparatuses are being developed. Stereoscopic image signals for displaying stereoscopic images can be obtained by acquiring stereoscopic image signals using a pair of left and right cameras. This method is appropriate for displaying a natural stereoscopic image, but needs to use two cameras to acquire an image. In addition, problems occurring when the acquired left image and right image are filmed or encoded, and different frame rates of the left and right images needs to be solved.

Stereoscopic image signals can also be acquired by converting 2D image signals acquired using one camera into 3D image signals. According to this method, the acquired 2D image (original image) is subjected to a predetermined signal process to generate a 3D image, that is, a left image and a right image. Accordingly, this method does not have the problems occurring when stereoscopic image signals which are acquired using left and right cameras are processed. However, this method is inappropriate for displaying a natural and stable stereoscopic image because two images are formed using one image. Therefore, for conversion of 2D image signals into 3D image signals, it is very important to display more natural and stable stereoscopic image using the converted 3D image signals.

2D image signals can be converted into 3D image signals using a modified time difference (MTD) method. In the MTD method, any one image selected from images of a plurality of previous frames is used as a pair frame of a current image that is 2D image signals. A previous image selected as a pair frame of a current image is also referred to as a delayed image. Selecting an image of a frame to be used as a delayed image and determining whether the delayed image is a left image or a right image are dependent upon the motion speed and direction. However, in this method, one frame is necessarily selected from the previous frames as a delayed image. Therefore, various characteristics of regions included in one frame are not sufficiently considered, such as a difference in a sense of far and near, a difference in motion direction and/or motion speed, or a difference in brightness and color. Accordingly, this method is inappropriate for displaying a natural and stable stereoscopic image.

### DETAILED DESCRIPTION OF THE INVENTION

### Technical Problem

The present inventive concept provides an apparatus and method for converting 2D image signals into 3D image signals, being capable of displaying a natural and stable stereoscopic image.

### Technical Solution

A method for converting 2D image signals into 3D image signals according to an embodiment of the present inventive concept includes: acquiring motion information about a current frame that is 2D input image signals; determining a motion type of the current frame using the motion information; and when the current frame is not a horizontal motion frame, applying a depth map of the current frame to a current image to generate 3D output image signals, wherein the depth map is generated using a horizontal boundary of the current frame.

According to an aspect of the current embodiment, when the current frame is the horizontal motion frame and a scene change frame, the depth map of the current frame is applied to the current image to generate 3D output image signals. When the current frame is the horizontal motion frame and is not the scene change frame, 3D output image signals are generated using the current image and a delayed image.

According to another aspect of the current embodiment, to apply the depth map, the horizontal boundary of the current frame is detected and then, whenever the detected horizontal boundary is encountered while moving in a vertical direction with respect to the current frame, a depth value is sequentially increased, thereby generating the depth map. In this case, before generating the depth map, the method may further include applying a horizontal averaging filter to the depth value.

A method for converting 2D image signals into 3D image signals according to another embodiment of the present inventive concept includes: acquiring motion information about a current frame that is 2D input image signals; determining a motion type of the current frame using the motion information; and when the current frame is a horizontal motion frame, determining whether the current frame is a scene change frame; and if the current frame is the horizontal motion frame and is not the scene change frame, generating 3D output image signals using a current image and a delayed image, and if the current frame is not the horizontal motion frame, or is the horizontal motion frame and the scene change frame, applying a depth map to the current image to generate 3D output image signals.

A method for converting 2D image signals into 3D image signals according to another embodiment of the present inventive concept includes: detecting a horizontal boundary in a current frame that is 2D input image signals; generating a depth map by increasing a depth value when the horizontal boundary is encountered while moving in a vertical direction with respect to the current frame; and applying the depth map to a current image to generate 3D output image signals.

An apparatus for converting 2D image signals into 3D image signals according to an embodiment of the present inventive concept includes: a motion information computing unit for acquiring motion information about a current frame that is 2D input image signals; a motion type determination unit for determining a motion type of the current frame using the motion information; and a 3D image generation unit for applying a depth map of the current frame to a current image to generate 3D output image signals when the current frame is not a horizontal motion frame, wherein the 3D image generation unit generates the depth map using a horizontal boundary of the current frame.

### Advantageous Effects

An apparatus and method for converting 2D image signals into 3D image signals according to the present inventive concept is appropriate for displaying a natural and stable stereoscopic image.

### DESCRIPTION OF THE DRAWINGS

FIG. 1 is a flowchart illustrating a conversion procedure of two dimensional (2D) image signals into three dimensional (3D) image signals, according to an embodiment of the present inventive concept;

FIG. 2 is a view illustrating an example of a positional change of a search point when a full search is used;

FIG. 3 shows images of reference frames for explaining how to determine a threshold value with respect to an error to be applied to Equation 2 in an embodiment of the present inventive concept;

FIG. 4 is a view illustrating an example of a procedure for applying a median filter;

FIG. 5 is a view for explaining a method of converting a 2D image into a 3D image based on a Ross effect, when an airplane moves from the left to the right, and a mountain that is a background is fixed;

FIG. 6 is a view illustrating an example of motion vectors in a block unit, when a camera is fixed and a subject moves;

FIG. 7 is a view illustrating an example of motion vectors in a block unit, when a subject is fixed and a camera moves;

FIG. 8 is a view illustrating an example of how to determine a left image and a right image using a delayed image and a current image;

FIG. 9 is a flowchart illustrating operation S50 of FIG. 1 in detail;

FIG. 10 show images for explaining a sense of depth with respect to a vertical position;

FIG. 11 is a view illustrating a Sobel mask;

FIG. 12 shows an image to which the Sobel mask of FIG. 11 is applied;

FIG. 13 is a view showing a result obtained by applying the Sobel mask of FIG. 11 to the image of FIG. 12;

FIG. 14 is a view illustrating an operation of forming a depth map using detected boundaries;

FIG. 15 is a view of the depth map formed using the operation of FIG. 14;

FIG. 16 is a view illustrating a variation application method and an occlusion region processing method, using a depth map;

FIG. 17 is a block diagram for explaining a processing procedure when a motion type changes;

FIG. 18 is a view showing a motion vector of a horizontal motion frame;

FIG. 19 is a view showing conversion results into a stereoscopic image using a delayed image and a current image, acquired by applying the embodiment of the present inventive concept described above to the motion vector of FIG. 18;

FIG. 20 is a view showing a depth map of a frame that is not a horizontal motion frame;

FIG. 21 shows stereoscopic images to which the depth map of FIG. 20 is applied, to according to an embodiment of the present inventive concept; and

FIG. 22 is a block diagram illustrating an apparatus of converting 2D image signals into 3D image signals, according to an embodiment of the present inventive concept.

### BEST MODE

Hereinafter, an embodiment of the present inventive concept will be described in detail with reference to the attached drawings. The current embodiment is described to explain a technical concept of the present inventive concept. Accordingly, the technical concept of the present inventive concept should not be construed to be limited by the current embodiment. Elements used in the current embodiment can also be differently referred to. If elements having different names are similar or identical to corresponding elements used in the current embodiment in terms of a structure or function, these elements having different names are also considered as being equivalent to corresponding elements used in the current embodiment. Likewise, even when a modified embodiment of the current embodiment illustrated in the attached drawings is employed, if the modified embodiment is similar or identical to the current embodiment in terms of a structure or function, both embodiments may be construed as being equalized.

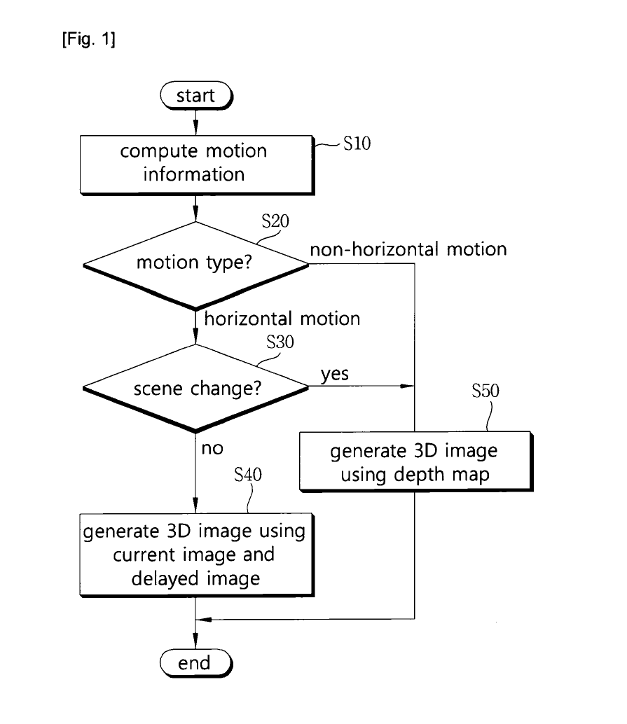

FIG. 1 is a flowchart illustrating a conversion procedure of two dimensional (2D) image signals into three dimensional (3D) image signals, according to an embodiment of the present inventive concept.

Referring to FIG. 1, first, motion information about a current frame is computed using 2D image signals (S10). This procedure of acquiring motion information is performed to acquire a material that can be used to determine a motion type of the current frame. This procedure includes a motion search procedure for acquiring a motion vector (MV) through motion estimation (ME) and post procedures for the acquired MV.

Motion Search

The motion search for acquiring MV through ME may be performed in various manners. For example, the motion search may be a partial search that is performed only on a predetermined region of a reference frame or a full search that is performed on the entire region of the reference frame. The partial search requires a short search time because a search range is narrow. On the other hand, the full search requires a longer search time than the partial search, but enables a more accurate motion search. According to an aspect of an embodiment of the present inventive concept, the full search is used. However, an embodiment of the present inventive concept is not limited to the full search. When the full search is used, the motion type of an image can be exactly determined through an accurate motion search, and furthermore, ultimately, a 3D effect of a display image can be improved.

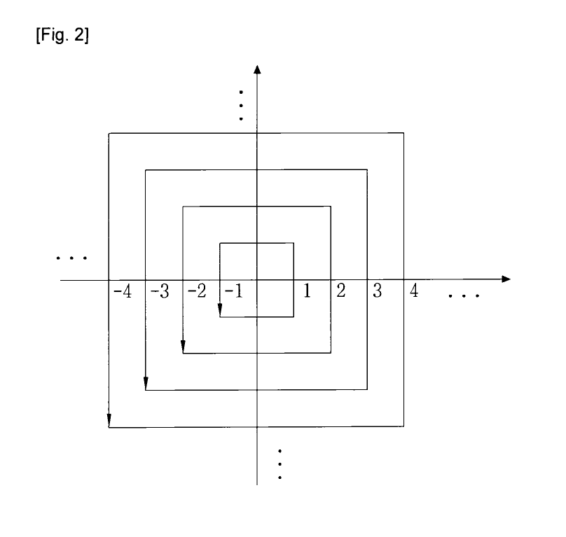

FIG. 2 is a view illustrating an example of a positional change of a search point when a full search is used in a pixel unit. Referring to FIG. 2, an error between a selected reference block and a current block is measured, while sequentially changing the search point in the reference frame in a counter-clockwise direction in this order of (−1,−1), (0,−1), (1,−1), (1,0), (1,1), (0,1), (−1,1), (—1,0), . . . ,. Herein, the coordinate of the search point is a difference between the position of the current block and the position of the reference block, that is, displacement (dx, dy). During the motion search, a search point having a minimum error during the displacement is changed is selected and the displacement of the selected search point is determined as MV (MVx, MVy) of the current block.

An error of each displacement (dx, dy) may be measured using Equation 1. In Equation 1, n and m respectively denote horizontal and vertical lengths of a block, and F(i, j) and G(i, j) respectively denote pixel values of the current block and reference block at (i, j).

$$Error ( dx , dy ) = {\sum }_{i = - n / 2}^{n / 2} {\sum }_{j = - m / 2}^{m / 2} \vert F ( i , j ) - G ( dx + i , dy + j ) \vert \qquad ( Equation 1 )$$

Post Procedures of MV

However, when a displacement having the minimum error is determined as MV, the determined MV is not always reliable. This is because a large minimum error or a large difference in MVs of neighboring blocks may indicate that the ME is inaccurate. Accordingly, the current embodiment further uses two post procedures to enhance reliability of MV. Although use of these two post procedures is desirable, only one of the post procedures may be used according to an embodiment.

A first post procedure to enhance reliability of MV is to remove MVs having an error value greater than a predetermined threshold value among all MVs acquired through motion search, from motion information. The first post procedure may be represented by Equation 2. In Equation 2, error denotes an error value of MV, and Threshold value denotes a threshold value to determine whether MV is valuable. According to Equation 2, when an error value of a specific MV is greater than the threshold value, it is assumed that ME is inaccurate, and the subsequent procedure such as an operation of determining motion type may use only MVs having an error value equal to or smaller than the threshold value.

f(error>Threshold value) MV_{—}x=0.MV_{—}y=0 [Equation 2]

A method of determining a threshold value with respect to an error is not limited. For example, various motion types of the current frame are considered: a case in which a scene change exists, a case in which a large motion exists, and a case in which a small motion exists. Then, the threshold value is determined in consideration of average error values of respective cases. In the current embodiment, the threshold value of Equation 2 is set at 250 based on 8×8 blocks. The reason for such setting of the threshold value will now be described in detail.

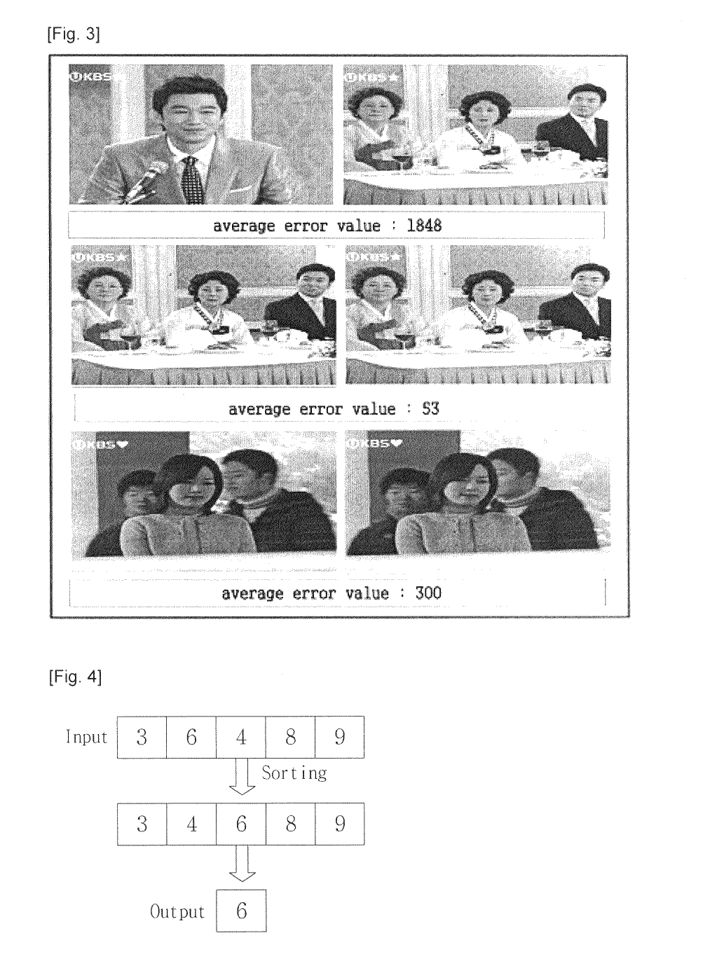

FIG. 3 shows images of reference frames for explaining how to determine the threshold value with respect to an error to be applied to Equation 2 in the current embodiment. In FIG. 3, upper frames have a scene change, intermediate frames have almost no motion, and lower frames have a large motion. Referring to FIG. 3, for an image having no relationship between previous and next frames, such as an image having a scene change, the average error value is 1848; for an image having a high relationship between previous and next frames, such as an image having almost no motion, the average error value is as small as 53; and for an image having a low relationship between previous and next frames, such as an image having a large motion to although not a scene change, the average error value is 300. Accordingly, in the current embodiment, the threshold value is set at 250 in consideration of average error values of the case in which a scene change exists, the case in which a large motion exists, and the case in which a small motion exists. However, the threshold value is exemplary.

A second post procedure to enhance reliability of MV acquired through the motion search is to correct wrong MVs. In general, motion is continuous, except for an edge of a subject. However, when MV is acquired through ME, a wrong MV that is very different from MVs of neighboring blocks may exist. The wrong MV may be discontinuous with respect to MVs of neighboring blocks.

In the current embodiment, in determining motion type, such wrong MV is corrected. The correcting method may use, for example, an average value or an intermediate value. However, the correcting method is not limited to those methods. For the correcting method using an average value, an average value of MVs of the current block and a plurality of neighboring blocks of the current block is set as MV of the current block. On the other hand, for the correcting method using an intermediate value, an intermediate value selected from MVs of the current block and a plurality of neighboring blocks of the current block is set as MV of the current block.

According to an aspect of the current embodiment, the correcting method using the intermediate value can be used using, for example, a Median Filter. The Median filter may be applied to each of a horizontal direction component and a vertical direction component of MVs of a predetermined number of neighboring blocks. FIG. 4 is a view illustrating an example of a procedure for applying a median filter. Referring to FIG. 4, when a plurality of input values 3, 6, 4, 8, and 9 pass through the median filter, their intermediate value, that is, 6 is output.

For example, let's assume that MVs of five neighboring blocks are (3, 5), (6, 2), (4, 2), (8, 4), and (9, 3), respectively. In this case, MV of the current block is (4, 2). However, if the Median filter is applied to each of the horizontal direction component and the vertical direction component of MVs of these five blocks, the output value may be (6, 3). Accordingly, when the post procedure for applying the median filter is performed according to an embodiment of the present inventive concept, MV of the current block is changed from (4, 2) into (6, 3).

As described above, in this procedure, first, MVs are acquired through the motion search in a predetermined size of block unit, and then the acquired MVs are subjected to a predetermined post procedure, thereby enhancing reliability of MVs.

Referring to FIG. 1, a motion type of the current frame is determined using MVs acquired in S10, that is, MVs which have been subjected to post procedures (S20). This operation is performed to determine whether the current frame is a horizontal motion frame. Whether the current frame is the horizontal motion frame can be determined using various methods. For example, whether the current frame is the horizontal motion frame can be determined by identifying a horizontal motion by referring to MVs of the current frame, that is, by using statistical information about horizontal direction components of MVs.

The current embodiment uses a negative method for determining whether the current frame is the horizontal motion frame. According to the negative method, whether the current frame is other type frame is determined according to a predetermined criterion, and then, if the current frame is not other type frame, the current frame is determined as the horizontal motion frame. For example, according to an aspect of the current embodiment, first, it is determined whether the current frame is ‘still frame’, ‘high-speed motion frame’ or ‘vertical motion frame.’ If the current frame is not any type of these frames, the current frame is determined as the horizontal motion frame. However, this negative method described above is exemplary. According to another embodiment of the present inventive concept, a predetermined criterion (for example, a horizontal component of MV is larger than 0 but in such a range that the current frame is not the high-speed motion frame, and a vertical component of MV is 0 or in a very small range) for determining a horizontal motion frame is set and only when the predetermined criterion is satisfied, the current frame is determined as a horizontal motion frame.

An example of determining whether the current frame is a ‘still frame’, a ‘high-speed motion frame’ or a ‘vertical motion frame’ will now be described in detail.

<Determining Whether the Current Frame is a Still Frame>

The still frame refers to an image in which an object does not move when compared with that of a reference frame. For the still frame, both a camera and the object do not move, and MV also has zero or a very small value. It may be called as a freeze frame. Accordingly, when the ratio of blocks having MV of which MV horizontal and vertical components (MVx) and (MVy) are zero or very small to all the blocks in one frame is high, the current frame can be determined as the still frame. For example, if the ratio of blocks having MV of which MV horizontal and vertical components (MVx) and (MVy) to all the blocks is 50% or more, the current image can be determined as the still image. However, this determination method is exemplary. If the current frame is the still frame, a stereoscopic image is generated only using an image of the current frame, not using a delayed image, which will be described later.

<Determining Whether the Current Frame is a High-Speed Motion Frame>

The high-speed motion frame refers to an image in which an object moves very quickly when compared with that of a reference frame. For the high-speed motion frame, the object and a camera move relatively very quickly and MV has a very large value. Accordingly, even when it is determined whether the current frame is the high-speed motion frame, MV can be used. For example, by referring to a ratio of blocks having MV larger than a predetermined value (using an absolute value or a horizontal component of MV) to all the blocks, it can be determined whether the current frame is the high-speed motion frame. The criterion of the size of MV or the ratio to determine whether the current frame is the high-speed motion frame may vary and can be appropriately determined using statistic data of various samples.

In the high-speed motion frame, a movement distance of the object per unit time is large. For example, when the object moves quickly in a horizontal direction and a delayed image is used as a pair image of the current frame, a horizontal variance is very large due to high speed and thus, it is very difficult to synthesize left and right images. Accordingly, in the current embodiment, for the high-speed motion image, the current frame, not the delayed image, is used as a pair image of the current frame.

<Determining Whether the Current Frame is a Vertical Motion Frame>

The vertical motion frame refers to an image in which an object moves in a vertical direction when compared with that of a reference frame. For the vertical motion frame, the object and a camera have a relative motion in the vertical direction, and a vertical component of MV has a value equal to or greater than a predetermined value. According to the current embodiment, the vertical motion frame also refers to an image in which an object moves in, in addition to the vertical direction, a horizontal direction, that is, in a diagonal direction. In general, when a vertical variance occurs in left and right images, it is difficult to synthesize the left and right images. Even when the left and right images are synthesized, it is difficult to display a natural stereoscopic image having a 3D effect. In addition, whether the current frame is the vertical motion frame can be determined using MV, specifically a ratio of blocks having vertical component (MVy) of MV being greater than a predetermined value. In the current embodiment, like the high-speed motion frame, the current frame is used as a pair image of the current frame.

As described above, according to an aspect of the current embodiment, first, it is determined whether the current frame is a still frame, a high-speed motion frame, or a vertical motion frame. When the current frame is any one frame selected from the still frame, the high-speed motion frame, and the vertical motion frame, operation S50 is performed to generate a stereoscopic image only using the current image. On the other hand, when the current frame is not any frame selected from the still frame, the high-speed motion frame, and the vertical motion frame, it is determined that the current frame is a horizontal motion frame. In the case of the horizontal motion image, a previous image is used as a pair image of the current frame. To do this, operation S30 is performed.

Referring to FIG. 1, if the current frame is determined as a horizontal motion frame, it is determined whether the current frame is a scene change frame (S30). The scene change frame refers to a frame in which a scene change occurs when compared to a previous image used as a reference frame. The reason for determining whether the current frame is the scene change frame when the current frame has been determined as the horizontal motion frame will now be described in detail.

As described above, according to the current embodiment, when the current frame is the horizontal motion frame, a delayed image is used as a pair image of the current image. However, if there is a scene change between the current frame and a previous frame used as the delayed image, even when the current frame is determined as the horizontal motion image, the delayed image cannot be used. This is because if the delayed image is used when the scene change occurs, different scene images may overlap when a stereoscopic image is displayed. Accordingly, if the current frame is determined as the horizontal motion frame, the scene change needs to be detected.

The scene change can be detected using various methods. For example, whether the scene change occurs can be detected by comparing statistic characteristics of the current frame and the reference frame, or by using a difference in pixel values of the current frame and the reference frame. However, in the current embodiment, the scene change detection method is not limited. Hereinafter, a method using brightness histogram will be described as an example of the scene change detection method that can be applied to the current embodiment. The method using brightness histogram is efficient because it can be easily embodied and has small computation quantities. In addition, even in the case of a motion scene, the level of brightness of a frame does not change largely. Therefore, this method is not affected by the motion of a subject or camera.

The method using brightness histogram is based on the fact that when scene change occurs, a large brightness change may occur. That is, when scene change does not occur, color distributions and brightness distributions of respective frames may be similar to each other. However, when scene change occurs, respective frames have different color distributions and brightness distributions. Accordingly, according to this method using brightness histogram, as described in Equation 3, when the difference in brightness histograms of consecutive frames is greater than a predetermined threshold value, the current frame is determined as a scene change frame.

$${D}_{i} = {\sum }_{j = 0}^{255} \vert {H}_{i - 1} ( j ) {H}_{i} ( j ) \vert > T \qquad ( Equation 3 )$$

where Hi(j) denotes a brightness histogram of a j level at an i th image, H denotes the level number of brightness histogram, and T is a threshold value for determining whether a scene change occurs and is not limited. For example, T can be set using neighboring images in which scene change does not occur.

Referring to FIG. 1, when the current frame is the horizontal motion frame and is not the scene change frame, a 3D image is generated using the current image and the delayed image (S40). On the other hand, when the current frame is any one frame selected from the still frame, the high-speed motion frame, and the vertical motion frame, or when the current frame is the horizontal motion frame and the scene change frame, a 3D image, that is, left and right images, is generated using a depth map of the current image (S50). Each of the cases will now be described in detail.

Generation of 3D Image Using Delayed Image (S40)

In operation S40, when the current frame is the horizontal motion frame and is not the scene change frame, a pair image of the current frame is generated using the delayed image and a 3D image, that is left and right images, is generated. As described above, converting a 2D image having horizontal motion into a 3D image using a delayed image is based on a Ross phenomenon belonging to a psychophysics theory. In the Ross phenomenon, a time delay between images detected through both eyes is considered as a important factor causing a 3D effect.

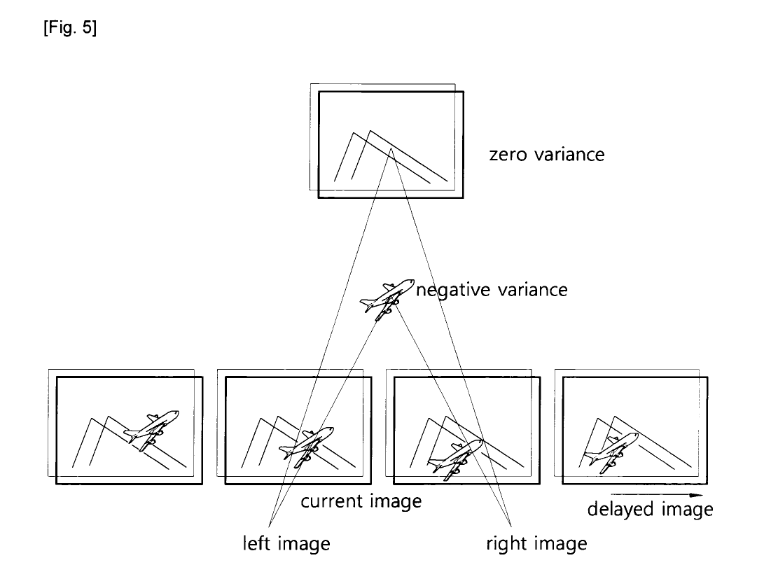

FIG. 5 is a view for explaining a method of converting a 2D image into a 3D image based on a Ross effect, when an airplane moves from the left to the right, and a mountain that is a background is fixed. Referring to FIG. 5, left and right eyes view the mountain that is a background and the airplane, and in this case, a variance occurs in the subject due to a difference between a left image and a right image. The airplane has a negative variance and thus is viewed protruding from a screen. Therefore, the airplane is focused before the screen. However, for the background, left and right eyes are focused on the screen and thus, the variance is zero.

As described above, when the delayed image is used as a pair image of the current image, it needs to determine left and right images using the current image and the delayed image. The left and right images may be determined in consideration of, for example, a motion object and a motion direction of the motion object. If the motion object or the motion direction are wrongly determined and thus left and right images are altered, a right stereoscopic image cannot be obtained.

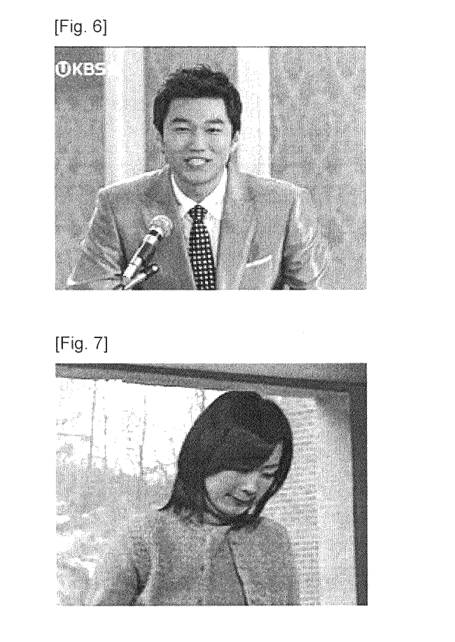

Determining a motion object is to determine whether the motion object is a camera or a subject. The motion object can be determined through MV analysis. FIG. 6 is a view illustrating an example of MVs in a block unit, when a camera is fixed and a subject moves, and FIG. 7 is a view illustrating an example of MV of a block unit, when a subject is fixed and a camera moves. Referring to FIGS. 6 and 7, when a camera moves, motion occurs in the entire screen and thus, MVs also occur in the entire image, on the other hand, when the subject moves, MVs occurs only in a region where the moving subject exists. Accordingly, for determining the motion object, when the number of blocks having MV is greater than a predetermined threshold value, it is determined that the camera has moved; on the other hand, when the number of blocks having MV is equal to or smaller than the predetermined threshold value, it is determined that the subject has moved.

When the motion object is determined as described above, a motion direction is determined through MV analysis. The motion direction may be determined according to the following rule.

In the case that the motion object is a camera, if MV, specifically, a horizontal component (MVx) of MV has a positive value, it is determined that the camera moves toward the right side, on the other hand, if MV has a negative value, it is determined that the camera moves toward the left side. In the case that the motion object is a subject, opposite results can be obtained. That is, if the MV has a positive value, it is determined that the subject moves toward the left side, but if the MV has a negative value, it is determined that the subject moves toward the right side.

When the motion direction of the camera or the motion direction of the subject is determined, right image and left image are selected from the current image and the delayed image, by referring to the determined motion direction. The determination method is shown in Table 1.

TABLE 1

| Type | Direction(MV) | Left image | Right image |
|---|---|---|---|
| Subject | Left (+) | Delayed image | Original image |
| Subject | Right (−) | Original image | Delayed image |
| Camera | Left (+) | Original image | Delayed image |
| Camera | Right (−) | Delayed image | Original image |

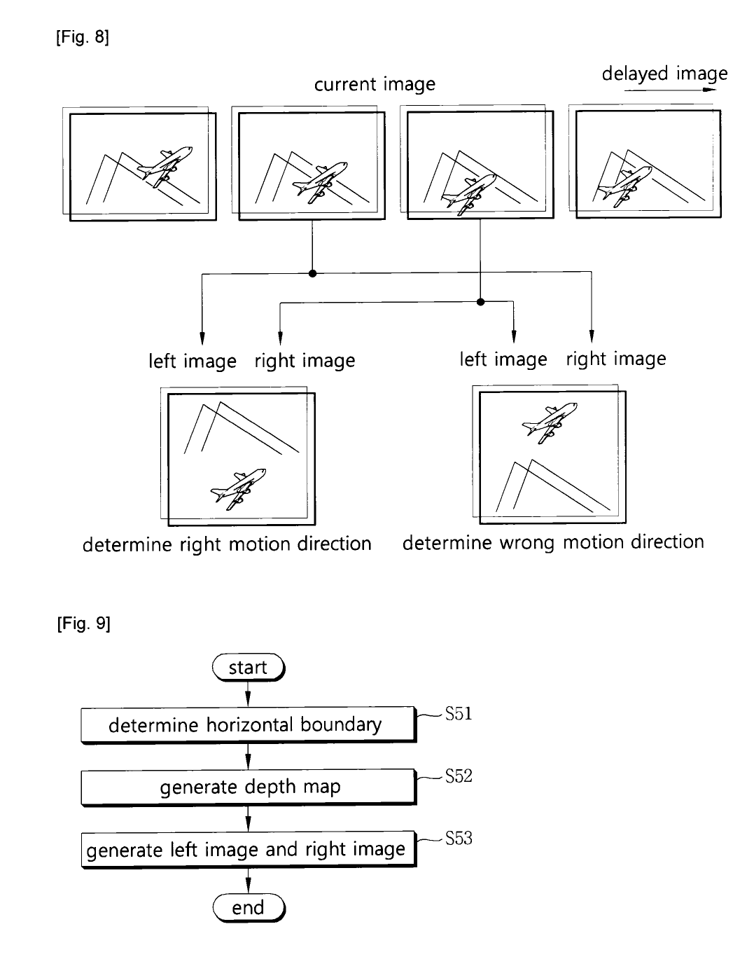

FIG. 8 is a view illustrating an example of how to determine the left image and the right image using the delayed image and the current image. Referring to FIG. 8, an airplane moves from the left side to the right side and a mountain is fixed. In addition, the camera is fixed. Like in the view illustrated in FIG. 5, the airplane is positioned before the mountain. In this case, when a stereoscopic image is generated using the current image as the left image and the delayed image as the right image, a negative variance is applied to the airplane and thus the air plane is viewed to protrude from the screen, but a zero variance is applied to the mountain and the mountain is viewed to be fixed on the screen. However, if the motion direction is inappropriately determined and the left image and the right image are altered, the mountain can be viewed being located before the airplane although, in fact, the airplane is positioned before the mountain.

Generation of 3D Image Using Depth Map (S50)

In operation S50, when the current frame is not the horizontal motion frame and is any one frame selected from a still frame, a high-speed motion frame, and a vertical motion frame, or when the current frame is the horizontal motion frame and the scene change frame, a 3D image is generated using only the current image, without use of the delayed image. Specifically, according to an embodiment of the present inventive concept, a depth map of the current image is formed and then, left and right images are generated using the depth map. FIG. 9 is a flowchart illustrating these procedures in detail (operation S50).

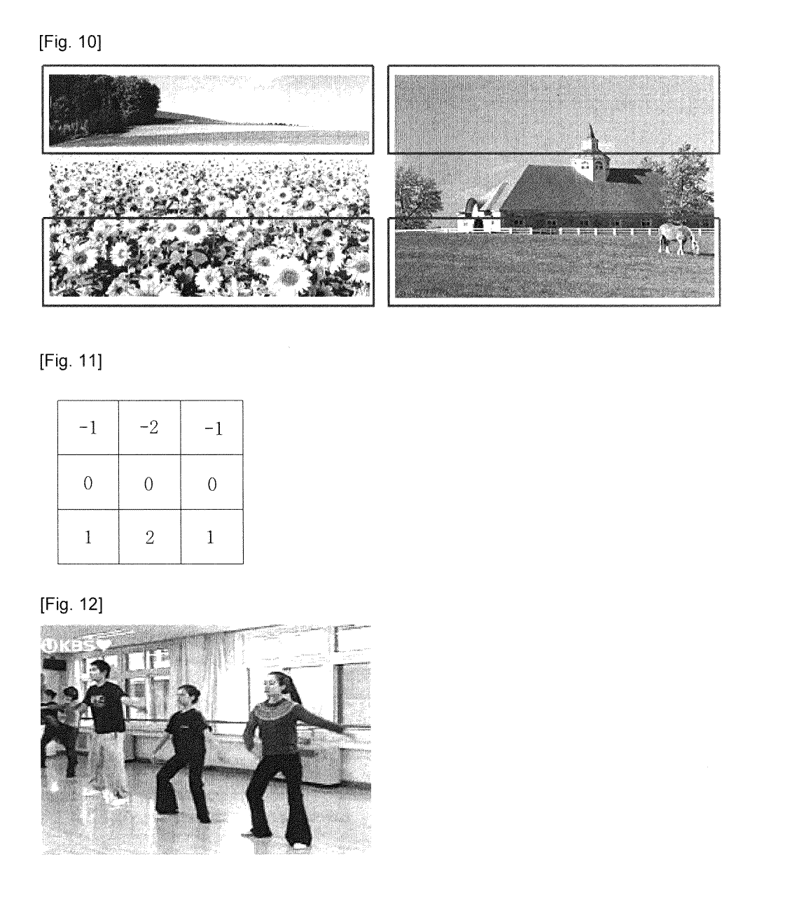

Referring to 9, a horizontal boundary in the current image is determined (S51), which is the first procedure to form a depth map according to an embodiment of the present inventive concept. In general, for a 2D image, factors causing a 3D effect on a subject include a sense of far and near, a shielding effect of objects according to their relative locations, a relative size between objects, a sense of depth according to a vertical location in an image, a light and shadow effect, a difference in moving speeds etc. Among these factors, the current embodiment uses the sense of depth according to a vertical location in an image. The sense of depth according to a vertical location in an image can be easily identified by referring to FIG. 10. Referring to FIG. 10, it can be shown that a portion located in a lower vertical position is close to a camera and a portion located in a higher vertical position is relatively far from the camera.

However, if the depth information is acquired only using a vertical position of an image, the generated image may be viewed to be inclined and a sense of depth between objects may not be formed. To compensate for this phenomenon, an embodiment of the present inventive concept uses the boundary information, specifically horizontal boundary information between objects. This is because there is necessarily a boundary between objects, and only when a difference of variances occurs at the boundary, different senses of depth according to objects can be formed. In addition, the current embodiment uses the sense of depth according to a vertical location.

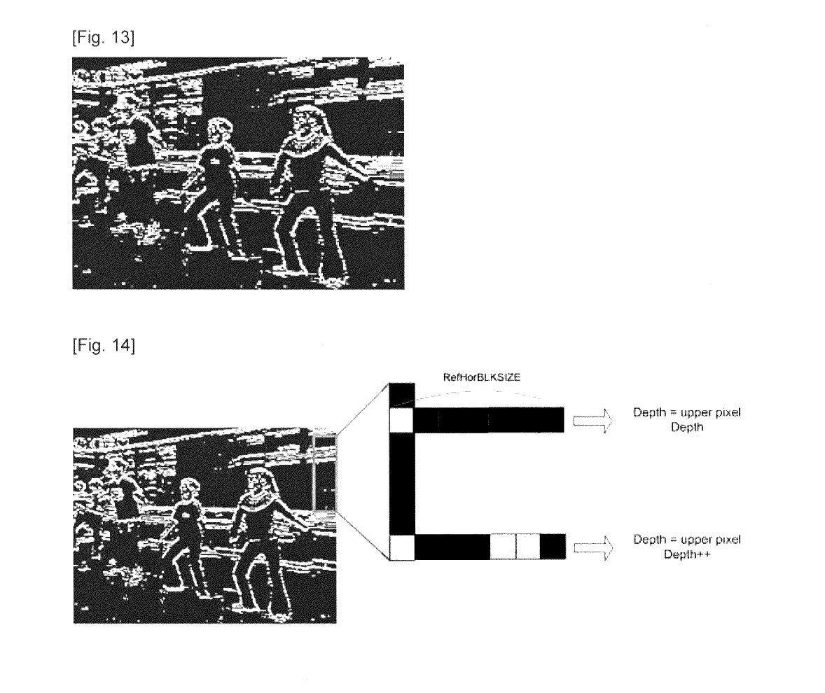

According to an embodiment of the present inventive concept, a method of computing a horizontal boundary is not limited. For example, the horizontal boundary may be a point where values of neighboring pixels arranged in a vertical direction are significantly changed. A boundary detection mask may be a Sobel mask or a Prewitt mask. FIG. 11 is a view illustrating the Sobel mask, and when the Sobel mask is used to detect a boundary of an image of FIG. 12, a result shown in FIG. 13 can be acquired.

Referring to FIG. 9, a depth map is generated using the acquired boundary information. According to a method of generating the depth map, a depth value is increased when a horizontal boundary is encountered, while moving from the upper portion to the lower portion in a vertical direction. When the depth map is generated using this method, an object located in a lower vertical position can have a sense of depth being relatively close to the camera, and an object located in an upper vertical position can have a sense of depth being relatively far from the camera.

However, if the depth value is increased whenever a horizontal boundary is encountered, a level of sensibility with respect to small errors is high and a depth map contains many noises. In the current embodiment, to solve this problem, noises can be removed before and after the depth map is generated.

When the depth map is not yet generated, whether the depth value is increased is determined by referring to neighboring portions of the detected horizontal boundary, that is, both-direction neighboring portions of the detected horizontal boundary arranged in a horizontal direction. For example, when a horizontal boundary is encountered but any boundary is not detected in both-direction neighboring portions of the detected horizontal boundary arranged in the horizontal direction, the detected horizontal boundary is determined as a noise. However, when the same boundary is detected in any one of the both-direction neighboring portions of the detected horizontal boundary arranged in the horizontal direction, the detected horizontal boundary is determined as a boundary, not a noise, and thus the depth value is increased. When the depth map has been generated, noises are removed using a horizontal averaging filter.

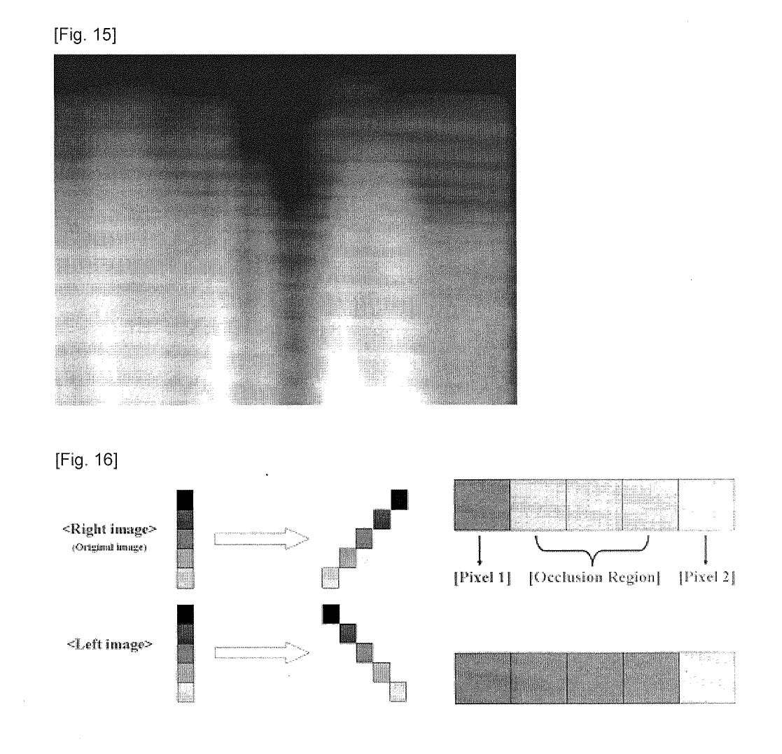

The procedure for generating a depth map using a detected boundary is illustrated in FIG. 14, and the generated depth map is illustrated in FIG. 15. Referring to FIG. 14, with respect to a boundary detected in a vertical direction, the depth value is sequentially increased, and noises are removed by referring to information about neighboring pixels in the horizontal direction. The resultant depth map is shown in FIG. 15.

Referring to FIG. 9, a left image and a right image are generated using the generated depth map (S53). In an embodiment of the present inventive concept, the generated depth map is applied to the current image and both the left and right images can be newly generated. However, the current embodiment is not limited thereto. For example, according to another embodiment of the present inventive concept, the current image is determined as any one image of the left image and the right image, and then the generated depth map is applied to generate the other image.

In the current embodiment in which the left and right images are generated using the current image, the variance value acquired from the depth map is partially applied to the current image to generate a left image and a right image. For example, if the maximum variance is 17 pixels, the depth map is applied such that the left image has the maximum variance of 8 pixels and the right image has the maximum variance of 8 pixels.

When the left image and the right image are generated using the depth map-applied current frame, occlusion regions may need to be appropriately processed to generate a realistic stereoscopic image. In general, an occlusion region is formed when variances applied to consecutive pixels arranged in a horizontal direction are different from each other. In an embodiment of the present inventive concept, when neighboring pixels in a horizontal direction have different variances, a region between the pixels having different variances is interpolated using the smaller variance.

FIG. 16 is a view illustrating the variance application method and an occlusion region processing method. Referring to FIG. 16, with respect to an average variance, when a right image is generated, pixels having small variances move toward the right side and pixels having large variances move toward the left side. On the other hand, when a left image is generated, pixels having small variances move toward the left side and pixels having large variances move toward the right side. In addition, when an occlusion region is present between a first pixel Pixel 1 having a relatively small variance and a second pixel Pixel 2 having a relatively large variance, the occlusion region is interpolated with the variance of Pixel 2 having the small variance.

However, in the case in which variances of the depth map are applied to the current image to generate left and right images, as described above, when the motion type changes, an unstable screen change may occur due to a large difference in variances applied. Specifically, in a case in which a previous frame of the current frame is the horizontal motion frame and a stereoscopic image is generated using the delayed image and the current image, and the current frame is not the horizontal motion frame and a depth map is applied thereto, or in a case in which a depth map is applied to the current image to generate left and right images, and for the next frame of the current frame, the left and right images are acquired using the delayed image and the current image, it is highly likely that the generated stereoscopic image is unstable.

Accordingly, according to an embodiment of the present inventive concept, to prevent formation of such unstable stereoscopic images, motion types of previous and next frames of the current frame are referred to when the depth map is applied. In general, the number of previous frames to be referred to (for example, about 10) can be larger than the number of next frames to be referred to (for example, 1-6). This is because for previous frames, the memory use is unlimited, but for next frames, the memory use is limited because the next frames need to be stored in a memory for application of the present procedure. However, this embodiment is exemplary and when the memory use is unlimited, the number of previous frames to be referred to can be smaller than or the same as the number of next frames to be referred to. Herein, what the motion type is referred to means that, when operation S50 is applied to generate a stereoscopic image, the depth map is applied after determining that the previous frame or the next frame is a frame to which operation S40 is applied or a frame to which operation S50 is applied.

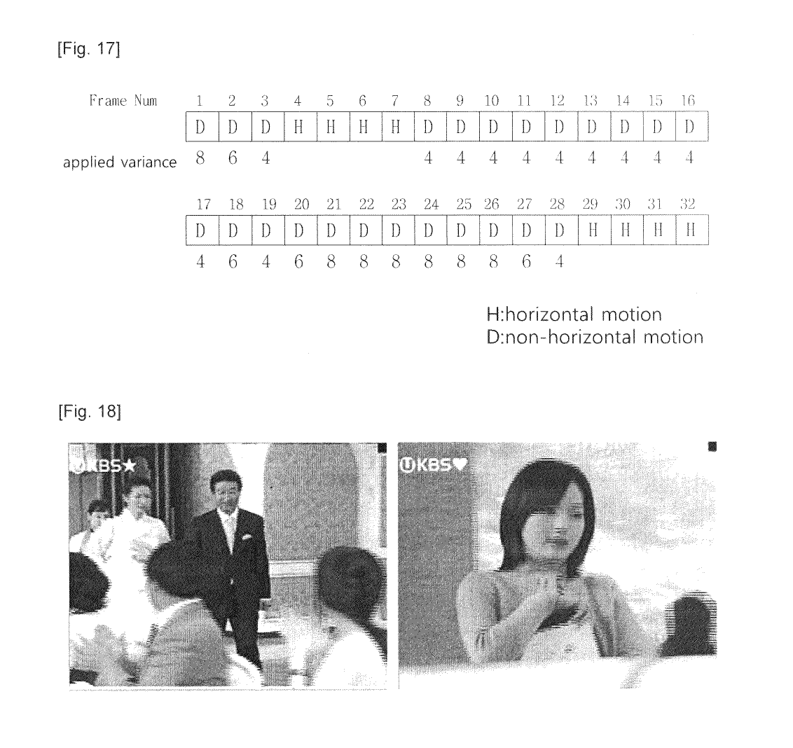

The procedure when the motion type is changed will now be described in detail with reference to FIG. 17. In FIG. 17, the numeral reference disposed on respective blocks denotes a frame number, D in each block denotes that the corresponding frame is a frame that is not a horizontal motion frame (hereinafter, referred to as ‘first frame’) and H in each block denotes that the corresponding frame is a horizontal motion frame (hereinafter, referred to as ‘second frame’). For convenience of description, it is assumed that a scene change point does not exist. In addition, in FIG. 17, the numeral reference under each block denotes an applicable maximum variance.

Referring to FIG. 17, when the motion type is changed from the first frame to the second frame, the maximum variance applied to the first frame is gradually reduced. On the other hand, when the motion type is changed from the second frame to the first frame, the applied maximum variance is gradually increased. As described above, when the motion type is changed, a gradual change in the applied maximum variance may prevent an unstable screen change that is caused by a large difference in applied variances.

### MODE OF THE INVENTION

Hereinafter, an experimental example will be described in detail with reference to the embodiments of the present inventive concept which have been described above.

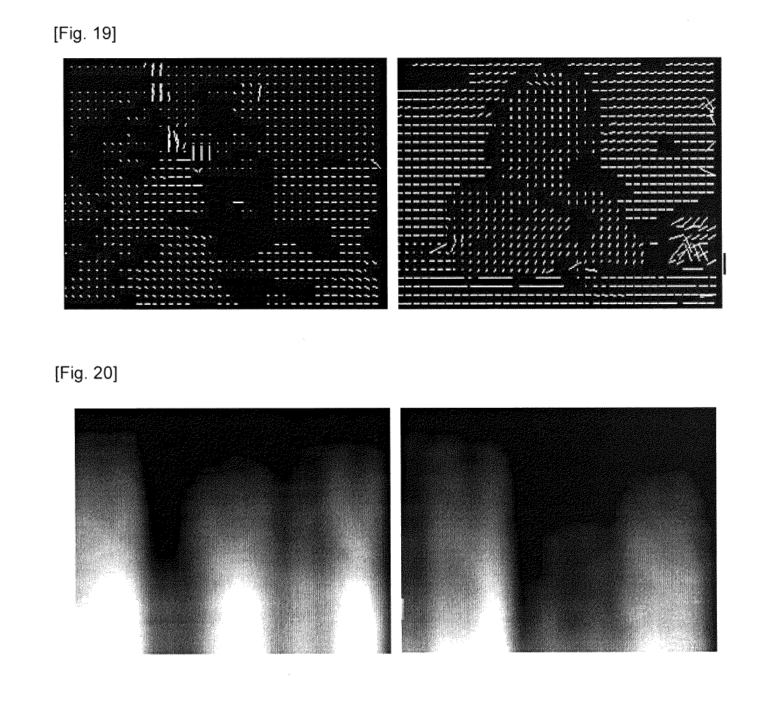

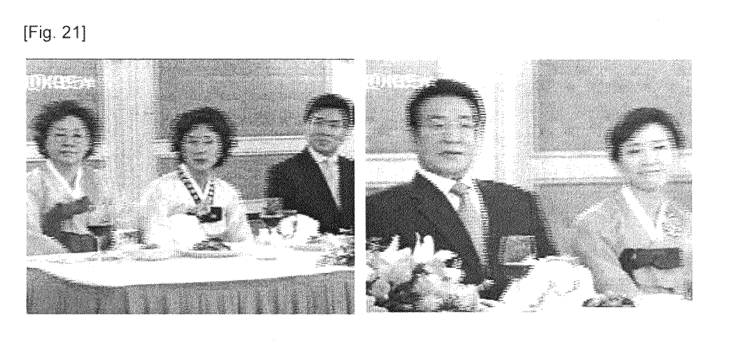

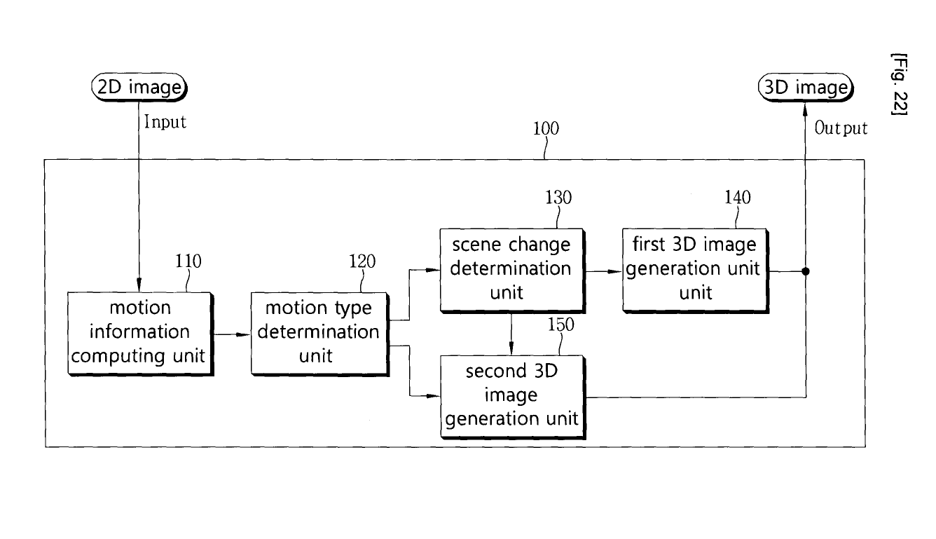

FIG. 18 shows a MV of a horizontal motion frame, FIG. 19 shows conversion results into a stereoscopic image using a delayed image and a current image, acquired by applying the an embodiment of the present inventive concept described above, FIG. 20 is a view of a depth map of a frame that is not a horizontal motion frame, and FIG. 21 show stereoscopic images to which the depth map of FIG. 20 is applied according to an embodiment of the present inventive concept. Referring to FIG. 20, it can be seen that a positive variance is applied to an upper portion of an image and thus, the upper portion of the image is viewed to be recessed, and a negative variance is applied to a lower portion of the image and thus, the lower portion of the image is viewed to protrude. Referring to FIG. 21, it can be seen that various variances are applied to subjects according to the location of the subjects.

FIG. 22 is a block diagram illustrating an apparatus 100 for converting 2D image signals into 3D image signals, according to an embodiment of the present inventive concept. The block diagram of FIG. 22 is used to embody the conversion procedures illustrated in FIG. 1, and each of the conversion procedures illustrated in FIG. 1 can be performed in a single unit illustrated in FIG. 22. However, the current embodiment is exemplary, and any one procedure of FIG. 1 can be performed in two or more units, or two or more procedures of FIG. 1 can be performed in one unit.

Referring to FIG. 22, the apparatus 100 for converting 2D image signals into 3D image signals include a motion information computing unit 110, a motion type determination unit 120, a scene change determination unit 130, a first 3D image generation unit 140, and a second 3D image generation unit 150. The motion information computing unit 110 applies a full search to a current frame of input 2D image signals to search for MV, and performs a post procedure, such as Equation 1 and Equation 2, on the searched MV. The motion type determination unit 120 determines whether the current frame is a horizontal motion frame or another type motion frame, that is, a still frame, a high-speed motion frame, or a vertical motion frame. The scene change determination unit 130 determined whether the current frame is a scene change frame, when the determination unit 120 has determined that the current frame is a horizontal motion frame. When the scene change determination unit 130 determines that the current frame is not the scene change frame, the signals are applied to the first 3D image generation unit 140, but when the scene change determination unit 130 determines that the current frame is the scene change frame, the signals are applied to the second 3D image generation unit 150.

The first 3D image generation unit 140 generates a stereoscopic image using a delayed image and a current image. On the other hand, the second 3D image generation unit 150 uses only the current image, specifically generates a depth map of the current image and a stereoscopic image is generated using the depth map. When the second 3D image generation unit 150 generates the depth map, according to an embodiment of the present inventive concept, first, a horizontal boundary is detected and then whenever the detected horizontal boundary is encountered while moving in a vertical direction with respect to the current frame, a depth value is increased. In addition, when a previous or next frame of the current frame is the horizontal motion frame for which the first 3D image generation unit 140 generates a stereoscopic image, the applied maximum variance may be gradually increased or reduced.

While the present inventive concept has been particularly shown and described with reference to exemplary embodiments thereof, it will be understood by those of ordinary skill in the art that various changes in form and details may be made therein without departing from the spirit and scope of the present inventive concept as defined by the following claims.

1. A method of for converting 2D image signals into 3D image signals, the method comprising:
acquiring motion information about a current frame that is 2D input image signals;
determining a motion type of the current frame using the motion information; and
when the current frame is not a horizontal motion frame, applying a depth map of the current frame to a current image to generate 3D output image signals,
wherein the depth map is generated using a horizontal boundary of the current frame.

2. The method of claim 1, wherein when the current frame is the horizontal motion frame and a scene change frame, the depth map of the current frame is applied to the is current image to generate 3D output image signals.

3. The method of claim 1, wherein when the current frame is the horizontal motion frame and is not a scene change frame, 3D output image signals are generated using the current image and a delayed image.

4. The method of claim 1, wherein to apply the depth map,
the horizontal boundary of the current frame is detected and then, whenever the detected horizontal boundary is encountered while moving in a vertical direction with respect to the current frame, a depth value is sequentially increased, thereby generating the depth map.

5. The method of claim 4, before generating the depth map, further comprising applying a horizontal averaging filter to the depth value.

6. A method of for converting 2D image signals into 3D image signals, the method comprising:
acquiring motion information about a current frame that is 2D input image signals;
determining a motion type of the current frame using the motion information; and
when the current frame is a horizontal motion frame, determining whether the current frame is a scene change frame; and
if the current frame is the horizontal motion frame and is not the scene change frame, generating 3D output image signals using a current image and a delayed image, and
if the current frame is not the horizontal motion frame, or is the horizontal motion frame and the scene change frame, applying a depth map to the current image to generate 3D output image signals.

7. The method of claim 6, wherein the depth map is generated using a horizontal boundary of the current frame.

8. The method of claim 6, wherein to apply the depth map,
a horizontal boundary of the current frame is detected and then, whenever the detected horizontal boundary is encountered while moving in a vertical direction with respect to the current frame, a depth value is sequentially increased, thereby generating the depth map.

9. The method of claim 6, wherein the acquiring of the motion information comprises:
acquiring motion vectors of the current frame using a reference frame, in a predetermined size of block unit;
measuring errors between the current frame and the reference frame, with respect to the motion vectors so as to select motion vectors having an error equal to or smaller than a predetermined threshold value; and
applying a Media filter to each of a vertical direction component and a horizontal direction component of the selected motion vectors.

10. The method of claim 6, wherein when the current frame is not any one frame selected from a still frame, a high-speed motion frame, and a vertical motion frame, the current frame is determined as the horizontal motion frame.

11. A method of for converting 2D image signals into 3D image signals, the method comprising:
detecting a horizontal boundary in a current frame that is 2D input image signals;
generating a depth map by increasing a depth value when the horizontal boundary is encountered while moving in a vertical direction with respect to the current frame; and
applying the depth map to a current image to generate 3D output image signals.

12. The method of claim 11, further comprising applying a horizontal averaging filter to the detected horizontal boundary.

13. The method of claim 11, wherein the generating of 3D output image signals comprises dividing a variance of the depth map and applying the divided variance to the current image to generate a left image and a right image.

14. A method of claim 13, wherein an occlusion region that is formed when variances of consecutive pixels arranged in a horizontal direction are different from each other in the left image or the right image is interpolated using a smaller variance than the other variances.

15. An apparatus for converting 2D image signals into 3D image signals, the apparatus comprising:
a motion information computing unit for acquiring motion information about a current frame that is 2D input image signals;
a motion type determination unit for determining a motion type of the current frame using the motion information; and
a 3D image generation unit for applying a depth map of the current frame to a current image to generate 3D output image signals when the current frame is not a horizontal motion frame,
wherein the 3D image generation unit generates the depth map using a horizontal boundary of the current frame.
